(19) United States
(12) Patent Application Publication
(10) Pub. No.: US 2010/0148530 A1
(43) Pub. Date: Jun. 17, 2010

(54) INTERIOR TRIM PART

(75) Inventor: Rudiger Michler, Leverkusen (DE)

Correspondence Address: BUTZEL LONG;IP DOCKETING DEPT, 350 SOUTH MAIN STREET, SUITE 300, ANN ARBOR, MI, 48104, US

(73) Assignee: Johnson Controls Interiors GmbH & Co. KG, Burscheid (DE)

(21) Appl. No.: 12/531,472

(22) PCT Filed: Feb. 19, 2008
(86) PCT No.: PCT/EP2008/001249

§ 371 Date: Jan. 8, 2010

(30) Foreign Application Priority Data
Mar. 16, 2007 (DE) 10 2007 013 374.1

(51) Int. Cl. B60R 13/02; B29C 70/78

(52) U.S. Cl. 296/1.08; 156/245

(57) ABSTRACT

The invention relates to a method for the production of a component, in particular an interior trim part for a motor vehicle, in which a planar decor film (1) is three-dimensionally preformed by deep drawing in a deep-drawing tool and then, in an injection molding tool, the back side of the decor film (1) is provided with a plastic support. According to the invention, the deep drawing of the decor film (1) is carried out by a combination tool (5) directly in the injection mold. The invention also relates to a component produced in this manner, in particular an interior trim part for a motor vehicle.

### CROSS REFERENCE TO RELATED APPLICATIONS

The present application is a U.S. National Stage filing of International Application No. PCT/EP2008/001249, filed on Feb. 19, 2008, titled “Component, in particular interior trim part for a motor vehicle, and method of production” which claims priority to German Patent Application No. DE 10 2007 013 374.1, filed Mar. 16, 2007, the entire disclosures of which are incorporated herein by reference.

### BACKGROUND

The present disclosure relates to a method for producing a component, in particular an interior trim part for a motor vehicle, in which a two-dimensional decorative film is three-dimensionally preformed by thermoforming in a thermoforming mold and the rear side of the decorative film is subsequently provided with a plastic support in an injection mold. The present disclosure also relates to a component produced in this way, in particular an interior trim part for a motor vehicle.

It is known for two-dimensional decorative films to be three-dimensionally preformed by thermoforming in a thermoforming mold and subsequently placed in an injection mold, in which the rear side of the decorative film is provided with a plastic by in-mold lamination. This provides the finished component with the required stiffness as a support after removal from the mold. In this respect, reference is made to the following document [0004] German patent application DE 10 2004 060 810 A1, published Jun. 29, 2006, in the name of ELLENRIEDER et al., relates to a method for producing a plastic molded part from a film material of transparent plastic in which the film material is printed on one side by means of a printing process, is shaped by a thermoforming process and, after shaping, is provided with a transparent plastic from the printed side by in-mold lamination. In order to improve the previously known method, it is proposed here that the film material is provided with a scratch-resistant layer on its side facing away from the printed side. Furthermore, this document relates to a plastic molded part produced by this method.

On this basis, the invention addresses the problem of reducing the effort involved in producing components of this type.

### SUMMARY

In one exemplary embodiment, the present disclosure relates to a method for the thermoforming of a decorative film taking place in a combination mold directly in the injection mold. As a result, the effort involved in producing components of this type is reduced significantly.

In one particular exemplary embodiment of the present a embodiment in a first step the decorative film is preferably heated. This heating of the decorative film preferably takes place in this case by using infrared heaters.

According to a further exemplary embodiment of the present disclosure, it is provided that the heated decorative film is brought between the mold halves of the combination mold, the lower mold half of which, which is preferably provided with negative-pressure connections, performs the function of a thermoforming mold, the application of the negative pressure causing the decorative film to be brought up against the surface of the lower mold half and three-dimensionally deformed in a way corresponding to the contour thereof. According to a further exemplary embodiment of the present disclosure, the upper mold half is subsequently lowered onto the lower mold half and forms with the latter a complexly formed cavity, into which the polymer melt is injected for forming the plastic support.

In the case of another exemplary embodiment, it is provided that the forming of the plastic support takes place by transfer molding of plastics materials when the mold halves are closed. In the case of a alternate exemplary embodiment, it is provided that the forming of the plastic support takes place by laminating of plastics materials when the mold halves are closed.

In a further alternate exemplary embodiment of the present disclosure the venting of the combination mold takes place by using porous steels in the mold halves; and in the case of a similar alternate exemplary embodiment, the venting of the combination mold takes place by using inserts made from porous steels, wherein the inserts are selectively located in the mold halves.

In a further alternate exemplary embodiment of the present disclosure additional cooling of the mold, in particular cooling of critical regions of the mold, takes place by selectively blowing in gases through the porous steel material.

In a further alternate exemplary embodiment of the present disclosure component, in particular an interior trim part for a motor vehicle, is formed by being produced by the method according to the disclosed exemplary embodiments.

### BRIEF DESCRIPTION OF THE FIGURES

The production sequence is represented schematically and by way of example in the Figures of the drawings, in which:

FIG. 1 shows the heating of the decorative film of the component according to the exemplary embodiment of the disclosure in a first method step preferably using infrared heaters;

FIG. 2 shows the feeding of the heated decorative film between the mold halves of a combination mold,

FIG. 3 shows the operation of thermoforming the decorative film on the lower mold half of the combination mold,

FIG. 4 shows the operation of in-mold laminating and cooling the decorative film in the combination mold.

### DETAILED DESCRIPTION

A method according to one exemplary embodiment serves for producing a component, in particular an interior trim part for use on a motor vehicle, in which a two-dimensional decorative film 1 is three-dimensionally preformed by thermoforming in a thermoforming mold. In one step the rear side of the decorative film 1 is subsequently provided with a plastic support in an injection mold. In one exemplary embodiment the thermoforming of the decorative film 1 takes place by means of a combination mold 5 directly in the injection mold.

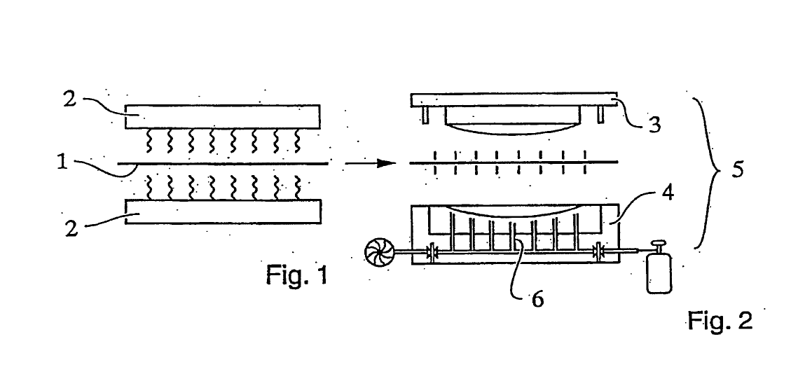

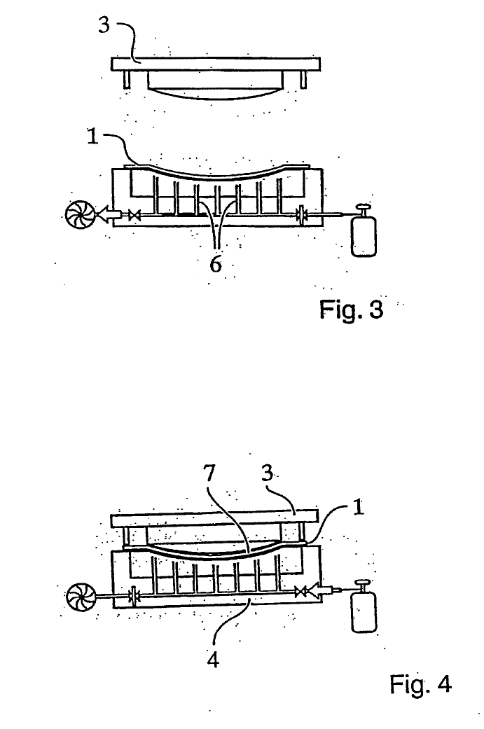

In a first step according to the exemplary embodiment, there is a heating of the decorative film 1, for example using infrared heaters 2 (FIG. 1). The warm decorative film 1 is subsequently brought between the mold halves 3, 4 of a combination mold 5, the lower mold half 4 of which can perform the function of a thermoforming mold and is provided with negative-pressure connections 6 (as best shown in FIG. 2). Application of the negative pressure causes the decorative film 1 to be brought up against the surface of the lower mold half 4 and three-dimensionally deformed in a way corresponding to the contour thereof (as best shown in FIG. 3). Subsequently, the upper mold half 3 is lowered onto the lower mold half 4 and forms with the latter a complexly formed cavity, into which the polymer melt 7 later representing the support is injected (as best shown in FIG. 4). In one alternative embodiment, it is possible to, instead of injection, transfer molding or laminating of plastics materials to take place when the mold halves 3, 4 are closed.

The venting of the combination mold 5 may take place by using porous steels (e.g. Toolvac) or inserts produced there from in the mold halves 3, 4. Furthermore, cooling of critical regions is possible by selectively blowing in gases (e.g. CO2) through these porous steels.

In addition, in one alternative embodiment, it may be provided that the decorative film 1 is provided with a grain effect during the in-mold lamination by impressing structures in the surface of the mold, see also DE 10 2005 039 600 A1, in the name of Becker et. A1, published Feb. 22, 2007. In one embodiment, the decorative film 1 may in this case be formed as a thin polypropylene film (<0.5 mm), also see WO2007028651A1, in the name of Paruchuri et al., published Mar. 15, 2007; in another embodiment, the decorative film 1 may consist of TPO (olefin-based thermoplastic elastomer) with a thickness of usually >0.5 mm.

As already mentioned, the embodiments represented are only examples of ways in which the invention can be implemented, and the invention is not restricted to them; rather, a variety of modifications and different formations are also possible.

1. A method for producing a component for use as an trim part in a motor vehicle, comprising the steps of:
selecting a two-dimensional decorative film;
three-dimensionally preforming the decorative film by thermoforming the decorative film in a thermoforming mold: and
subsequently providing the rear side of the decorative film with a plastic support in an injection mold wherein the thermoforming of the decorative film takes place in a combination mold in the injection mold.

2. The method of claim 1 further comprising the step of heating the decorative film prior to the step of three-dimensionally preforming the decorative film.

3. The method of claim 2 wherein the step of heating the decorative film comprising the step of using infrared heaters to increase the temperature of the decorative film.

4. The method of claim 3 further comprising the steps of locating the heated decorative film between mold halves of the combination mold: creating a negative-pressure in the lower mold half causing the decorative film to be brought up against the surface of the lower mold half and to be three-dimensionally deformed in a way corresponding to the contour thereof; and thermoforming the interior trim part to include the three-dimensionally formed decorative film.

5. The method of claim 4 further comprising the step of lowering the upper mold half onto the lower mold half to form a complexly formed cavity, into which a polymer melt is injected to form the plastic support for the decorative layer.

6. The method of claim 4 5 further comprising the step of forming the plastic support by transfer molding the plastics materials when the mold halves are closed.

7. The method of claim 45 further comprising the step of forming the plastic support by laminating of the plastics materials when the mold halves are closed.

8. The method of claim 5 further comprising the step of venting the combination mold by using porous steels in the mold halves.

9. The method of claim 1 further comprising the step of venting the combination mold using a mold inserts made from porous steels in the mold.

10. The method of claim 9 further comprising the step of cooling a portion of the mold by selectively blowing gases through the porous steels.

11. A component, in particular an interior trim part for use a motor vehicle including, a two-dimensional decorative film that has been three-dimensionally preformed by thermoforming, and a plastic support for supporting the decorative film wherein the component is formed by the method of claim 1.

12. A component produced by the method of claim 1.

13. The component of claim 12 wherein the component produced is for use as an interior trim part for use in a motor vehicle wherein the decorative layer will be viewable in the interior of the vehicle.
